(19) United States
(12) Patent Application Publication
(10) Pub. No.: US 2015/0044627 A1
(43) Pub. Date: Feb. 12, 2015

(54) DENTAL POSITIONER

(71) Applicant: German Enterprises, Inc., Dayton, OH (US)

(72) Inventor: Daniel Stuart German, Dayton, OH (US)

(73) Assignee: German Enterprises, Inc., Dayton, OH (US)

(21) Appl. No.: 13/964,763

(22) Filed: Aug. 12, 2013

(51) Int. Cl. A61C 7/00; G06F 17/50; A61C 7/08

(52) U.S. Cl. CPC A61C 7/002; A61C 7/08; G06F 17/50
USPC 433/24; 700/98

(57) ABSTRACT

Various embodiments of the present invention seek to alleviate patient discomfort and inconvenience by eliminating the need to take the dental impression. For some embodiments, a dental positioner appliance is fabricated from a digital model of optimally-aligned and optimally-fit teeth. Using the digital model removes the need to physically take a dental impression of a patient.

### BACKGROUND

1. Field of the Disclosure

The present disclosure relates generally to teeth and, more particularly, to positioning teeth.

2. Description of Related Art

There are various reasons for orthodontic work, ranging from improved appearance to improved dental health. For example, straight teeth are less likely to have problems with discoloration, uneven wear, and fractures. Given these various reasons, there are ongoing efforts in the field of orthodontics.

### SUMMARY

Various embodiments of the present invention seek to alleviate patient discomfort and inconvenience by eliminating the need to take the dental impression. For some embodiments, a dental positioner appliance is fabricated from a digital model of optimally-aligned and optimally-fit teeth. Using the digital model removes the need to physically take a dental impression of a patient.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A and 1B are flowcharts showing one embodiment of a process for improving alignment of teeth.

FIG. 2A is a diagram showing an example of misaligned teeth.

FIG. 2B is a diagram showing an example of properly aligned teeth.

FIG. 3 is a diagram showing an example of a thermoplastic aligner.

FIGS. 4A and 4B are flowcharts showing one embodiment of a process for optimally positioning teeth.

FIGS. 5A and 5B are diagrams showing two different embodiments of prescription forms.

FIG. 6 is a diagram showing one embodiment of a positioner.

FIGS. 7A through 7C are flowcharts showing another embodiment of a process for optimally positioning teeth.

### DETAILED DESCRIPTION OF THE EMBODIMENTS

People seek orthodontic work to improve the appearance of their teeth, or to decrease tooth-related problems, such as uneven wear and fractures. In properly positioning teeth, there are two main considerations, namely, alignment and fit. The goal of orthodontic work is to achieve both optimal alignment and optimal fit. However, currently, no orthodontic system is successful at achieving perfect alignment, and all systems generally fall short of making the maxillary teeth (top teeth) and mandibular teeth (bottom teeth) fit together ideally.

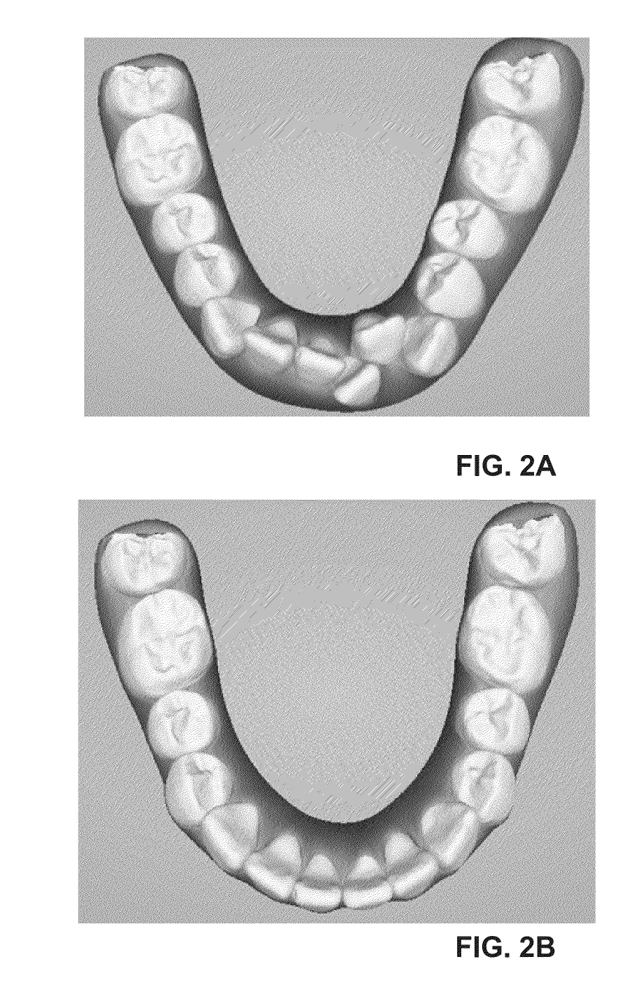

Proper alignment involves straightening misaligned teeth. For instance, FIG. 2A shows an example of misaligned teeth, while FIG. 2B shows an example of properly aligned teeth. As one can see from FIG. 2A, several of the front teeth (such as the incisors) are misaligned as compared to the diagram in FIG. 2B. This misalignment can make it difficult to maintain proper dental hygiene, in addition to being aesthetically unappealing.

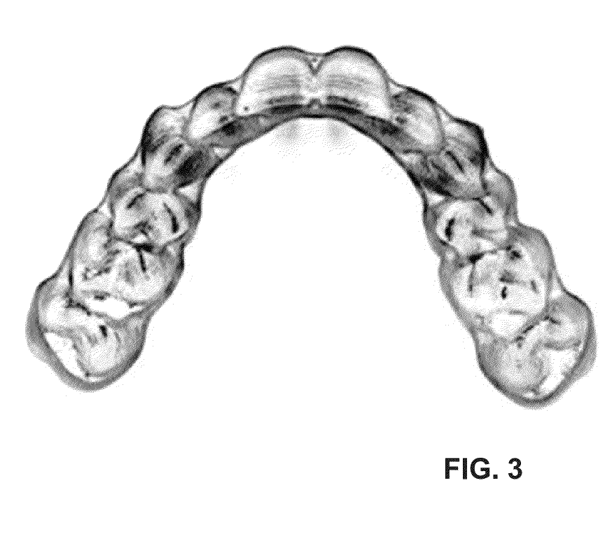

Various orthodontic systems exist to align teeth. For example, standard wire braces have been used to straighten teeth for decades. These wire braces are attached to the teeth and incrementally adjusted over time to bring the teeth into proper alignment. More recently, computer-driven orthodontic systems have been used to fabricate series of removable thermoplastic aligners. One example of an aligner, such as the Invisalign® brand thermoplastic aligner, is shown in FIG. 3. As shown in FIG. 3, the thermoplastic aligner models a set of teeth, and is designed to fit over a patient's teeth to apply gentle pressure to the appropriate teeth, thereby slowly moving the teeth into proper alignment.

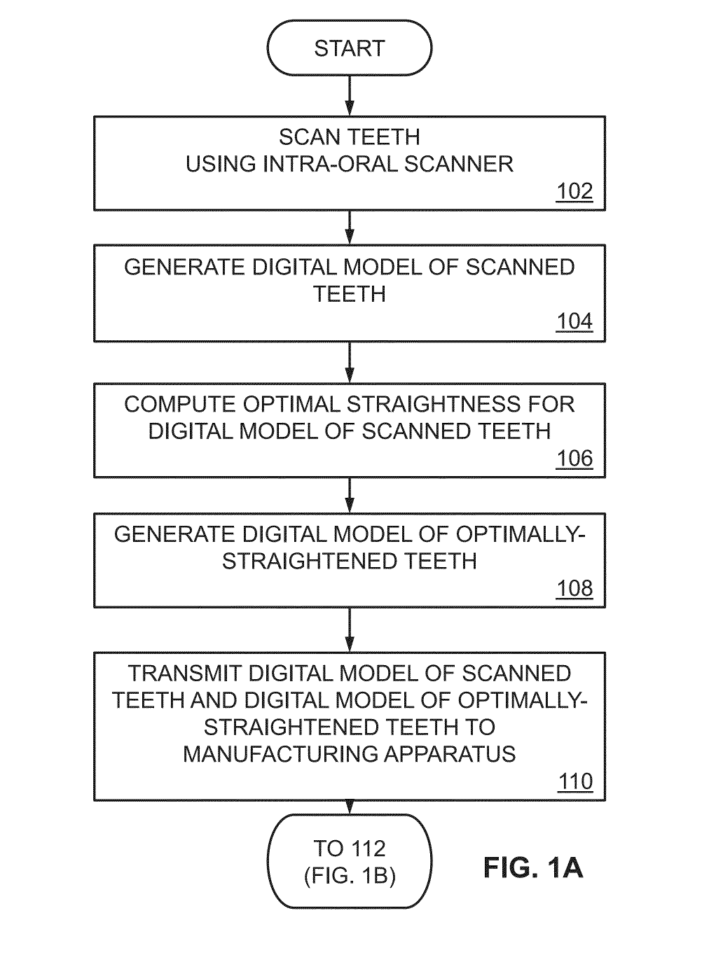

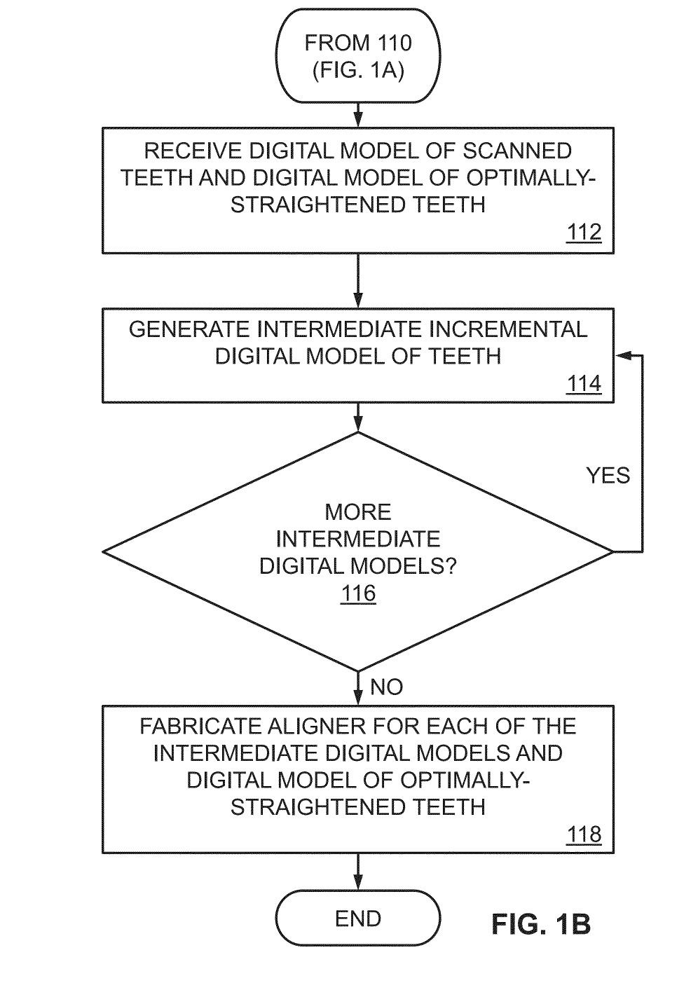

Each aligner is modeled to represent progressively straighter teeth. Thus, as a patient moves from one aligner to a subsequent straighter aligner, each aligner applies an incremental force to the teeth, thereby slowly moving the teeth into progressively straighter alignment. An example embodiment of a fabrication process for thermoplastic aligners for a patient with misaligned teeth is shown with reference to FIGS. 1A and 1B.

As shown in FIG. 1A, the fabrication process begins with scanning (102) of the patient's misaligned teeth using an intra-oral scanner. Preferably, approximately four millimeters (4 mm) of the surrounding gum tissue is also scanned (102). Examples of intra-oral scanners include the iTero® brand intra-oral scanner, by Align Technologies. After scanning (102), the system generates (104) a digital model of the misaligned teeth. From this digital model, the system computes (106) an optimal straightness, and generates (108) a digital model of optimally-straightened teeth. Here, a digital model of optimally-straightened teeth means a digital model of how the teeth should appear after completing a full course of braces (e.g., by wire braces, by thermoplastic aligners, etc.). The computation (106) and generation (108) of the digital model can be done through conventional computer-aided design (CAD) or computer-aided manufacturing (CAM) processes. The generated (108) digital model of the optimally-straightened teeth is then transmitted (110) to the manufacturer.

Continuing in FIG. 1B, the manufacturer receives (112) the digital model of both the scanned (102) misaligned teeth and the generated (108) optimally-straightened teeth. Using known computational processes (e.g., known CAD-CAM processes or morphing processes), the system generates (114) an intermediate incremental digital model of the patient's teeth. Preferably, the first intermediate incremental digital model represents a set of teeth that is slightly straighter than the originally-scanned misaligned teeth. If more intermediate digital models are needed (116), then the system recursively generates other intermediate digital models, each of which represents a set of teeth that is incrementally straighter than the previous digital model. This process repeats until it terminates with the previously-generated (108) optimally-straightened teeth. Upon generating (114) all of the necessary intermediate incremental digital models, the system then fabricates a thermoplastic aligner for each of the digital models. These thermoplastic aligners can be fabricated using molds, or by using a three-dimensional printer. Since the actual fabrication processes are known in the art, further discussion of the thermoplastic fabrication processes is omitted here.

Once fabricated, the thermoplastic aligners are provided to the patient, who wears the aligners for a fixed duration, starting with the aligner that is the closest representation of the misaligned teeth, and ending with the aligner that represents the optimally-aligned teeth. Completion of this full course results in improved or optimal alignment of the patient's teeth. Since similar processes, such as those employed for Invisalign® brand dental aligners, are known, further discussion of FIGS. 1A and 1B are omitted here.

What should be noted, however, is that, although the process outlined in FIGS. 1A and 1B (and other similar processes) are often used to address proper alignment, it may be very difficult to address the issue of proper fit using this process. And, often, this process does very little to address the issue of proper fit.

The issue of proper fit is remarkably different from the issue of proper alignment. Unlike alignment, which deals with the straightness of teeth, the issue of fit relates to how well the top teeth fit with the bottom teeth. As such, even though the top teeth and the bottom teeth may be straight, it is entirely possible that the top teeth do not fit optimally with the bottom teeth. Ideally, the top teeth should fit with the bottom teeth for optimal mastication (chewing). Stated differently, there is an optimal position that each top tooth should occupy with reference to its corresponding bottom teeth, and vice versa. Consequently, straightening a set of teeth (either top or bottom), standing alone, may be insufficient to remedy improper fit.

In cases where there is sufficiently-proper alignment but an improper fit, additional orthodontic work is usually performed by prescribing a dental positioner appliance, which continues the work that was left incomplete by the aligner (e.g., wire braces, thermoplastic aligners, etc.). Additionally, the positioner may sometimes improve less-than-optimal alignment. Thus, to date, the positioner appliances have been prescribed for implementation after patients have completed a full course of braces (either wire or thermoplastic).

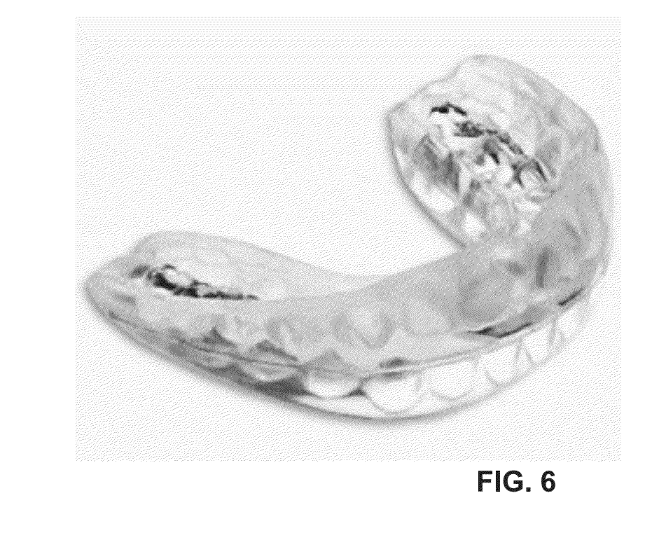

The positioner appliance is a solid single piece of rubber or plastic that has been fabricated from models of patient teeth, which have been physically straightened and optimally positioned in a laboratory according to a prescription. One example of a dental positioner appliance is shown in FIG. 6. As shown in FIG. 6, the dental positioner appliance comprises a mold of both the upper teeth and the lower teeth, with both sets of teeth being positioned to achieve an optimal fit between the top teeth and the lower teeth.

Since the dental positioner appliances are fabricated post-alignment, these positioners are usually made from impressions of patient teeth. Once the impressions are obtained, plaster molds are made from the impressions, and those plaster models are sent to a laboratory with a written prescription. The laboratory then places the teeth in an optimal position by cutting teeth from the model and resetting them in wax, all in accordance with the written prescription. The positioner appliance is then fabricated from the model of the optimally-aligned and optimally-fit teeth. As one can appreciate, unlike aligners (e.g., wire braces or thermoplastic aligners) that are capable of large movements of individual teeth, dental positioner appliances are only capable of smaller movements.

One of the main drawbacks in current processes for fabricating positioner appliances is that a separate dental impression is taken of straightened patient teeth, thereby subjecting the patient to the inconvenience and discomfort of taking the necessary dental impressions.

Various embodiments of the present invention seek to alleviate patient discomfort and inconvenience by eliminating the need to take the dental impression. Briefly, for some embodiments, a dental positioner appliance is fabricated from a digital model of optimally-aligned and optimally-fit teeth. Using the digital model removes the need to take a physical dental impression of a patient.

With this overview in mind, reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

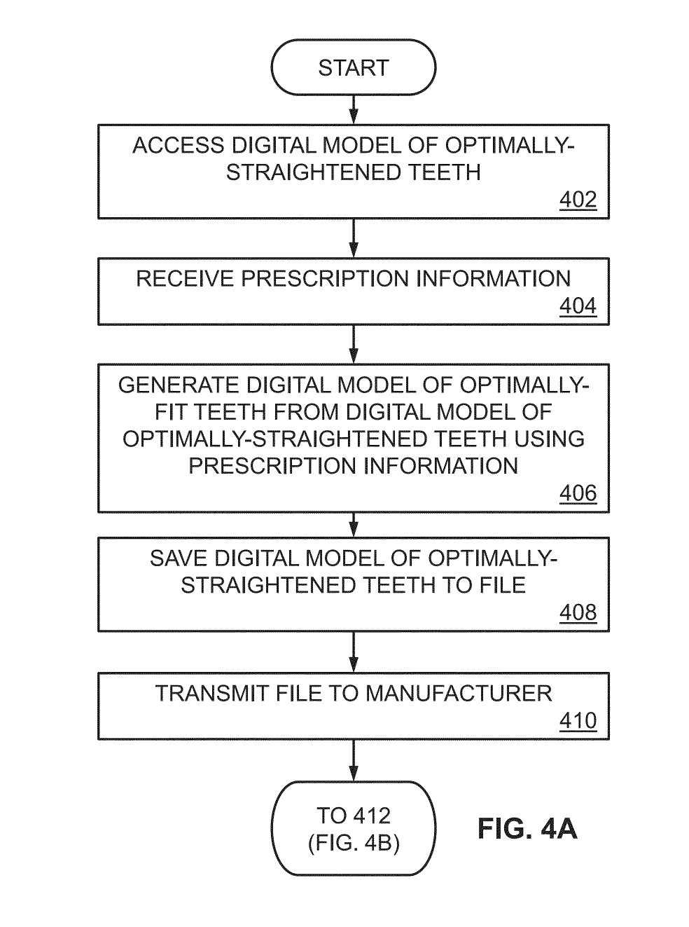

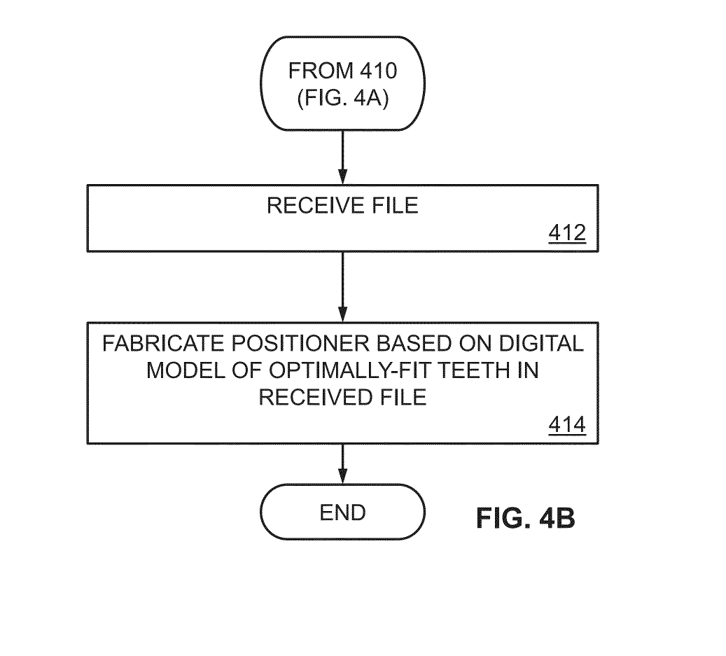

FIGS. 4A and 4B are flowcharts showing one embodiment of a process for optimally positioning teeth, which removes the inconvenience and discomfort of taking a physical dental impression of a patient. Specifically, FIG. 4A describes the process as executed by a computerized system. The starting point of FIG. 4A is with a digital model of optimally-straightened teeth, which was generated (108) in the alignment process of FIGS. 1A and 1B. Since the digital model represents a patient's teeth after it has been aligned, the digital model should be a digital replica of a patient's optimally-aligned dentition, similar to what one would obtain from a physical dental impression from a patient that has completed a full course of braces.

With this in mind, the process of FIG. 4A begins with accessing (402) the digital model of the optimally-straightened teeth. Using that digital model, a doctor completes a prescription for how the to achieve optimally-aligned teeth and how those teeth should be moved to achieve optimal fit. That prescription is the basis for fabricating the dental positioner appliance.

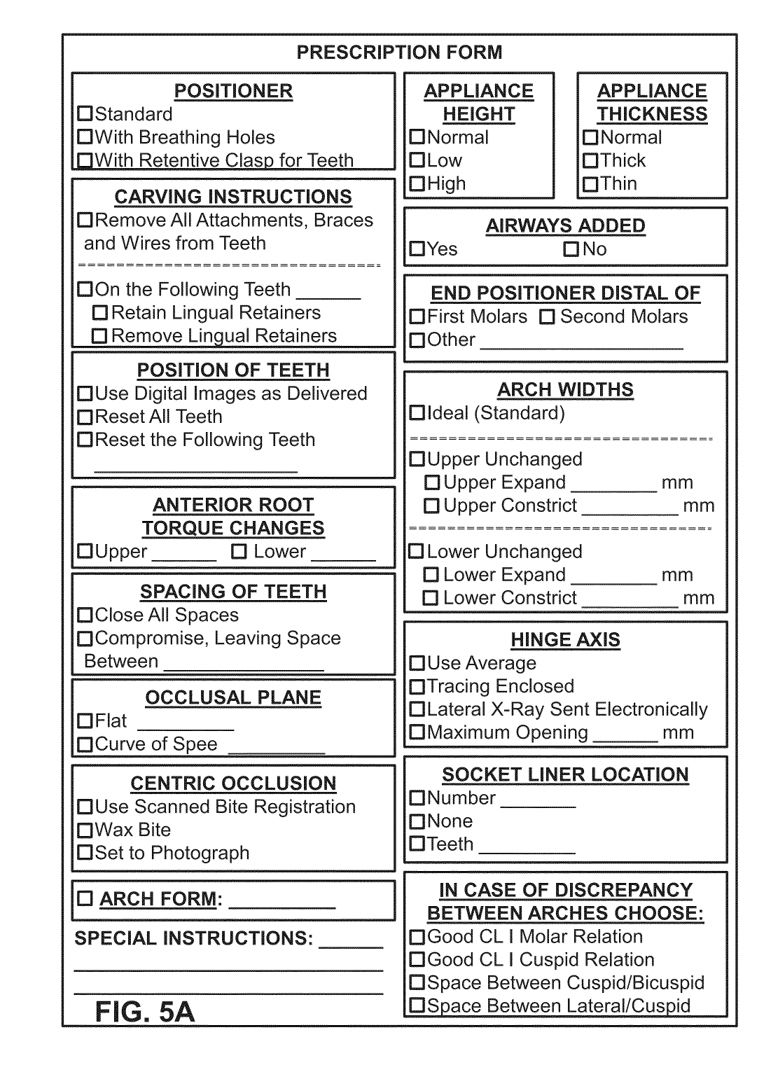

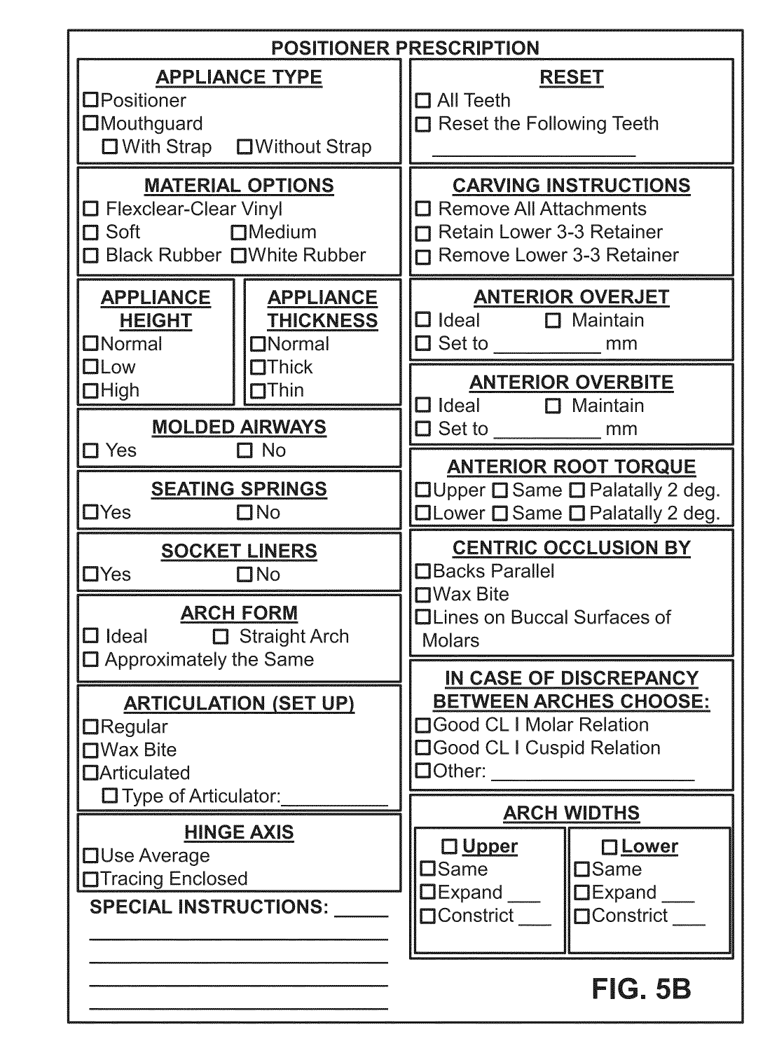

One should appreciate that the prescription form can be a paper form or, alternatively, a computer user interface (e.g., graphical user interface) through which a doctor can enter patient information and prescription information. By way of example, FIGS. 5A and 5B show two different embodiments of prescription forms. As shown in FIG. 5A, the types of information that can be provided in the prescription form include: positioner type (e.g., standard, with breathing holes, with retentive clasp for teeth, etc.); carving instructions (e.g., remove all attachments from teeth, remove lingual retainers for particular teeth, retain lingual retainers for particular teeth, etc.); how to determine the final position of the teeth (e.g., by using digital images as delivered, by resetting all teeth, by resetting only certain teeth, etc.); positioner appliance height (e.g., normal, low, high, etc.); positioner appliance thickness (e.g., normal, thick, thin, etc.); and a host of other prescription information, such as those shown in FIG. 5A. Also, as shown in FIG. 5B, Class I (or CL I) molar relation can be used as a basis for optimal fit, since CL II (Class II) molars represent a bite where the upper teeth are positioned forward of the lower teeth, and CL III (Class III) molars describe a bite where the lower teeth are positioned forward of the upper teeth.

Since one having skill in the art will understand the prescription information in FIG. 5A or 5B, and since one having skill in the art will understand how that prescription information applies to dental positioner appliances, all of the prescription information is not exhaustively discussed herein.

Continuing with FIG. 4A, after accessing (402) the digital model of optimally-straightened teeth, the system receives (404) the prescription information (e.g., the information shown in FIG. 5A or 5B). Using the prescription information, the system generates (406) a digital model of optimally-fit teeth from the digital model of the optimally-straightened teeth. This can be done using known CAD-CAM processes or various known digital morphing processes. The generated (406) digital model is then saved (408). For some embodiments, the digital model is saved as a “.stl” file that is compatible with conventional CAD-CAM systems. The saved (408) file is transmitted (410) to the manufacturer. Continuing with FIG. 4B, the manufacturer receives (412) the file, which contains the digital model of the optimally-fit teeth. The manufacturer then fabricates (414) a dental positioner appliance based on the digital model of the optimally-fit teeth. The dental positioner appliance can be fabricated using a mold, or other known processes for fabricating such appliances.

As one can see from FIGS. 4A and 4B, by using the digital model of the optimally-straightened teeth, which already exists as a result of the process of FIGS. 1A and 1B, there no longer exists any need to obtain a physical dental impression from a patient. As one can appreciate, the last data set in the alignment process, which is the digital replica of the optimally-aligned teeth, is the first data set in the fit process. Thus, there no longer exists any need to subject a patient to the inconvenience and discomfort of taking a physical dental impression. And, much of the conventional work of physically molding, carving, and moving teeth in wax can now be done virtually, using computer morphing or CAD-CAM processes. Since the last data set is a set of teeth that is both optimally aligned and optimally fit, the last set can potentially be used for direct fabrication of the positioner without revisions and detailed prescriptions.

Another advantage of using the same data for both alignment and fit is that it allows a single entity to offer uninterrupted and seamless service to the patient. For example, currently, one entity fabricates aligners while another entity fabricates dental positioners. By using the same data set for both alignment and fit, a single entity can coordinate the alignment and fit from the outset.

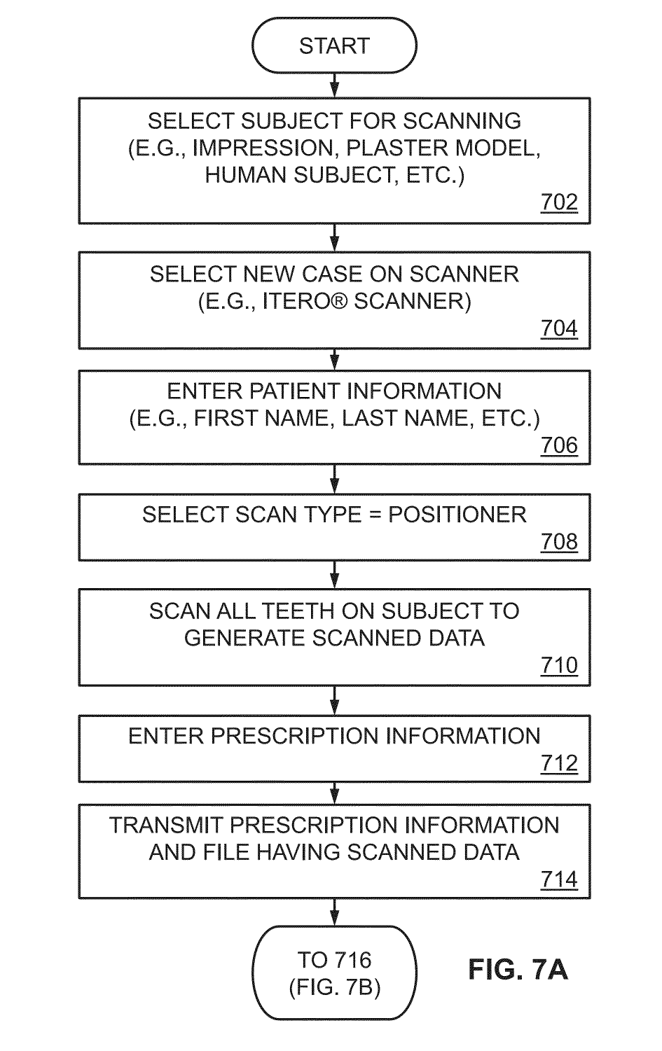

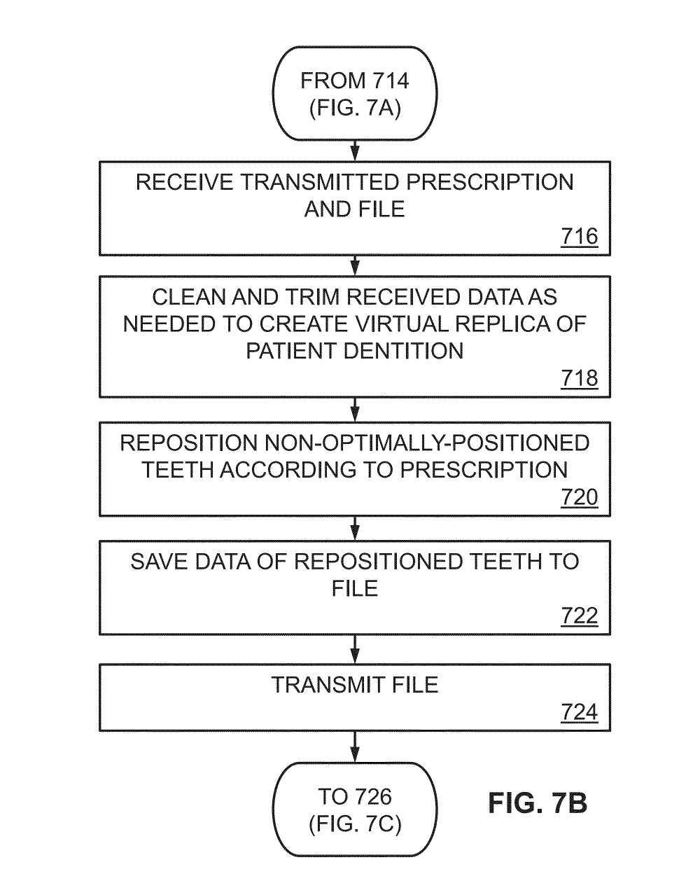

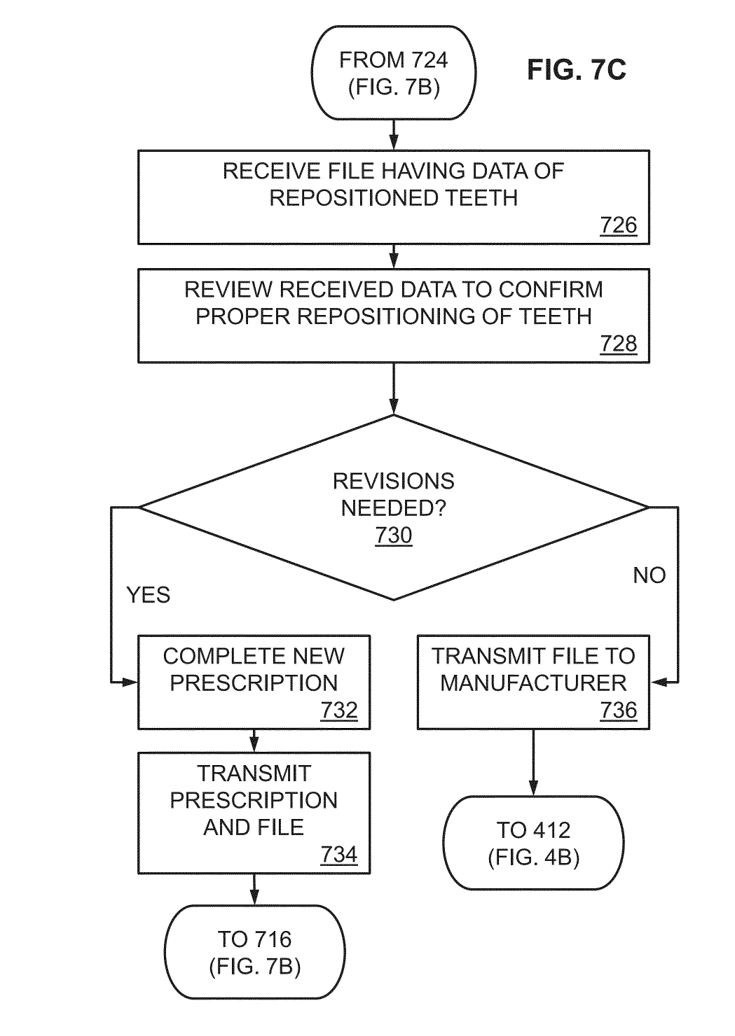

Having described, in general, one embodiment of a process for optimally positioning teeth, attention is turned to FIGS. 7A through 7C which shows another embodiment of a process for optimally positioning teeth. As shown in FIG. 7A, this embodiment of the process begins with selecting (702) a subject for scanning. That subject can be a human patient, a plaster model, or some other type of impression that is reflective of a patient's dentition. Once the subject is selected, the practitioner (e.g., doctor, dentist, orthodontist, etc.) selects (704) a new case on the scanner. For illustrative purposes, this particular embodiment shows an iTero® brand intra-oral scanner, from Align Technologies. Once a new case has been selected, the practitioner enters (706) patient information into the system. The patient information includes the patient's first name, last name, age, etc. Next, the practitioner selects (708) the scan type to be for a dental positioner appliance.

Once the preliminary information has been selected and entered (702-708), the practitioner scans (710) all of the subject's teeth in order to generate scanned data. Upon review of the scanned data, the practitioner then enters (712) prescription information. The prescription information may be entered using a graphical user interface, such as that shown in either FIG. 5A or FIG. 5B. The prescription information includes instructions relating to the arrangement of the patient's dentition for optimal fit and can include information, such as, for example, positioner type, carving instructions, position of teeth, anterior root torque changes, spacing of teeth, occlusal plane, centric occlusion, arch form, appliance height, appliance thickness, location of end of positioner, arch widths, hinge axis, socket liner location, etc., and any combination thereof. It should also be appreciated that additional prescription information can be included, should the practitioner deem that information to be necessary. The prescription information and the file having the scanned data is then transmitted (714) to a vendor that has the capability of cleaning the scanned file to produce a digital replica of the patient's dentition.

Continuing in FIG. 7B, the vendor receives (716) the prescription and the file having all of the transmitted patient data. That data is then cleaned and trimmed (718) to create a virtual replica of the patient's dentition. Thereafter, any non-optimally-positioned teeth are repositioned (720) according to the prescription. For some embodiments, that repositioning process is done digitally without the need to fabricate a plaster mold of the patient's teeth. Once repositioned (720), the data of the repositioned teeth are saved (722) to a file. Preferably, the file is a “.stl” file or other file that is compatible with various CAD-CAM systems. The saved (722) file is then transmitted back to the practitioner for review and confirmation.

Next, as shown in FIG. 7C, the practitioner receives (726) the file having the data of the repositioned teeth, and reviews (728) the data to confirm that the teeth are indeed properly repositioned for optimal fit. If the practitioner determines (730) that revisions are needed, then the practitioner completes (732) a new prescription to make the necessary adjustments to the fit, and then transmits (734) the new prescription and the file back to the vendor to repeat the process shown in FIG. 7B. Alternatively, if the practitioner determines (730) that no additional revisions are needed, then the practitioner transmits (736) the file to a dental positioner appliance manufacturer to have the dental positioner appliance fabricated. That fabrication process is described with reference to FIG. 4B.

As one can appreciate from the description of FIGS. 7A through 7C, orthodontic care can be streamlined by removing the need to obtain a physical dental impression from a patient. Furthermore, with digital models of a patient's dentition, much of the conventional work of physically molding, carving, and moving teeth in wax can now be done virtually, using computer morphing or CAD-CAM processes. Furthermore, as shown through FIGS. 7A through 7C, the dental professional can be a single point-of-contact for both alignment (e.g., full course of braces) and fit (e.g., dental positioner appliance). This increases the convenience to the patient, permits additional revenue for the dental professional, and provides a built-in incentive for practitioners to acquire or purchase these types of orthodontic care systems that are capable of addressing both alignment and fit.

Each of the steps in the processes of FIGS. 4A, 4B, 7A, 7B, and 7C may be implemented with appropriate computer processing logic, which can be implemented in hardware, software, firmware, or a combination thereof. In the preferred embodiment(s), the processing logic is implemented in software or firmware that is stored in a memory and that is executed by a suitable instruction execution system. If implemented in hardware, as in an alternative embodiment, the processing logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The flow charts of FIGS. 4A, 4B, 7A, 7B, and 7C show the architecture, functionality, and operation of a possible implementation of software for generating digital models of patient teeth. In this regard, each block represents a module, segment, or portion of code, which comprises one or more executable instructions for implementing the specified logical function(s). It should also be noted that in some alternative implementations, the functions noted in the blocks may occur out of the order noted in FIGS. 4A, 4B, 7A, 7B, and 7C. For example, two blocks shown in succession in FIGS. 4A, 4B, 7A, 7B, and 7C may in fact be executed substantially concurrently or the blocks may sometimes be executed in the reverse order, depending upon the functionality involved, as will be further clarified hereinbelow. Thus, any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

The program for generating the computer models of patient teeth, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any non-transient means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured via, for instance, optical scanning of the paper or other medium, then compiled, interpreted or otherwise processed in a suitable manner if necessary, and then stored in a computer memory.

Although exemplary embodiments have been shown and described, it will be clear to those of ordinary skill in the art that a number of changes, modifications, or alterations to the disclosure as described may be made. For example, while a “.stl” file is recited as a specific example of a file having digital models, it should be appreciated that other file types that can be used in CAD-CAM processes can also be used. Furthermore, while specific factors are recited in the prescription form of FIGS. 5A and 5B, it should be appreciated that additional information, which is not shown in either FIG. 5A or FIG. 5B, can be provided as part of the prescription or, alternatively, some of the information in either FIG. 5A or FIG. 5B can be omitted from other embodiments of the prescription form. All such changes, modifications, and alterations should therefore be seen as within the scope of the disclosure.

What is claimed is:

1. In orthodontic care, a method comprising:
scanning teeth using an intra-oral scanner;
generating a digital model of the scanned teeth;
computing an optimal straightness for the digital model of the scanned teeth;
generating a digital model of optimally-straightened teeth from the digital model of the scanned teeth using the computed optimal straightness;
generating intermediate incremental digital models of teeth, each intermediate incremental digital model representing progressively-straighter teeth;
transmitting the intermediate incremental digital models to an aligner manufacturer to fabricate aligners corresponding to the respective intermediate incremental digital models;
receiving the aligners from the aligner manufacturer;
progressively applying each of the aligners to the teeth, each aligner being applied at a corresponding time window, the progressive application of each of the aligners resulting in optimally-straightened teeth;
providing prescription information, the prescription information comprising instructions for arranging the optimally-straightened teeth for optimal fit;
generating a digital model of optimally-fit teeth using the accessed digital model of the optimally-straightened teeth and the prescription information; and
transmitting the digital model of the optimally-fit teeth to a positioner appliance manufacturer to fabricate a dental positioner appliance corresponding to the digital model of the optimally-fit teeth.

2. The method of claim 1, the prescription information being one selected from the group consisting of:
positioner type;
carving instructions;
position of teeth;
anterior root torque changes;
spacing of teeth;
occlusal plane;
centric occlusion;
arch form;
appliance height;
appliance thickness;
location of end of positioner;
arch widths;
hinge axis;
socket liner location; and
a combination thereof.

3. In a manufacturing system comprising a digital model of optimally-straightened teeth, the optimally-straightened teeth representing a patient's dentition, a method for fabricating a dental positioner appliance, the method comprising:
accessing the digital model of the optimally-straightened teeth;
receiving prescription information comprising an instruction, the instruction relating to an arrangement of the patient's dentition for optimal fit; and
generating a digital model of optimally-fit teeth using the digital model of the optimally-straightened teeth and the prescription information.

4. The method of claim 3, the digital model of optimally-straightened teeth being generated during an orthodontic alignment process.

5. The method of claim 4, further comprising saving the model of optimally-fit teeth to a file, the file being compatible with a computer-aided design (CAD) computer-aided manufacturing (CAM) system.

6. The method of claim 5, the file having a .stl extension.

7. The method of claim 3, further comprising fabricating the dental positioner appliance from the generated digital model of optimally-fit teeth.

8. The method of claim 3, the digital model of optimally-straightened teeth being generated by an intra-oral scan of a patient's teeth after the patient has completed a full course of braces.

9. The method of claim 3, the prescription information being one selected from the group consisting of:
positioner type;
carving instructions;
position of teeth;
anterior root torque changes;
spacing of teeth;
occlusal plane;
centric occlusion;
arch form;
appliance height;
appliance thickness;
location of end of positioner;
arch widths;
hinge axis;
socket liner location; and
a combination thereof.

10. A system for fabricating a dental positioner appliance, the system comprising:
processing logic to access a digital model of the optimally-straightened teeth, the optimally-straightened teeth representing a patient's dentition;
processing logic to receive prescription information comprising an instruction, the instruction relating to an arrangement of the patient's dentition for optimal fit; and
processing logic to generate a digital model of optimally-fit teeth using the digital model of the optimally-straightened teeth and the prescription information.

11. The system of claim 10, the digital model of optimally-straightened teeth being generated during an orthodontic alignment process.

12. The system of claim 11, further comprising processing logic to save the model of optimally-fit teeth to a file, the file being compatible with a computer-aided design (CAD) computer-aided manufacturing (CAM) system.

13. The system of claim 12, the file having a .stl extension.

14. The system of claim 12, further comprising means for saving the model of optimally-fit teeth to a file, the file being compatible with a computer-aided design (CAD) computer-aided manufacturing (CAM) system.

15. The system of claim 10, the digital model of optimally-straightened teeth being generated by an intra-oral scan of a patient's teeth after the patient has completed a full course of braces.

16. The system of claim 10, further comprising a mold to fabricate the dental positioner appliance from the generated digital model of optimally-fit teeth.

17. The system of claim 10, further comprising means for fabricating the dental positioner appliance from the generated digital model of optimally-fit teeth.

18. The system of claim 10, the prescription information being one selected from the group consisting of:
positioner type;
carving instructions;
position of teeth;
anterior root torque changes;
spacing of teeth;
occlusal plane;
centric occlusion;
arch form;
appliance height;
appliance thickness;
location of end of positioner;
arch widths;
hinge axis;
socket liner location; and
a combination thereof.
